(19) United States
(12) Patent Application Publication
(10) Pub. No.: US 2006/0112155 A1
(43) Pub. Date: May 25, 2006

(54) System and method for managing quality of service for a storage system

(75) Inventors: William J. Earl, Boulder Creek, CA (US); Dhanabal Ekambaram, Sunnyvale, CA (US)

Correspondence Address: DLA PIPER RUDNICK GRAY CARY US, LLP, 2000 UNIVERSITY AVENUE, E. PALO ALTO, CA, 94303-2248, US

(73) Assignee: Agami Systems, Inc.

(21) Appl. No.: 10/997,198

(22) Filed: Nov. 24, 2004

(51) Int. Cl. G06F 17/30

(52) U.S. Cl. 707/206

(57) ABSTRACT

The present invention provides a system and method for managing quality of service for a storage system that includes several file systems that share resources. The system may include a Quality of Service (QoS) manager and a request limitation process or “throttle” for limiting requests to the file systems based on measured operational data. The QoS manager employs various methods for managing quality of service including controlling memory usage of clean pages and other resources, admission control, and controlling the rate at which modified buffers are written to disk.

### TECHNICAL FIELD

The present invention relates generally to storage systems, and more particularly to a system and method for managing quality of service for a storage system.

### BACKGROUND OF THE INVENTION

A typical storage system, whether for files or for simple blocks within a logical device, makes use of a variety of internal resources, any of which could become overloaded at some point. For example, common resources of concern in a storage system are disk seeks (moving the disk head to a different area of the disk, usually measured as seeks per second), disk sequential throughput (reading or writing to adjacent locations, usually measured as megabytes per second), main memory space (for caching data for reading, for buffering writes waiting to be transferred to disk, and for caching metadata, such as the location of file data on the disk), main memory bandwidth (for transfers to and from the disks and the network and for CPU access, typically measured in megabytes per second), non-volatile memory (NVRAM) space (used for reliably holding pending writes until they are written to disk), NVRAM bandwidth, CPU time (for processing access protocols, scheduling data movement, and performing file system operations), and network bandwidth (for moving data in and out of the system). Systems where the disks are attached to one or more network ports and multiple disks share a port may also be concerned with disk access port bandwidth and queuing delays.

In typical storage systems, as the load increases, the throughput increases, up to the service capacity of the storage system. Then, as the load increases beyond what the storage system can handle, the throughput declines, due to congestion. This typically results from the increased length of internal queues, leading to locks on higher level resources being held longer, which in turn leads to longer queues for access to those higher level resources. The increase in queue length is particularly pronounced when some requests take much longer than others to be handled, leading to what is well known as the “convoy effect.”

Highway traffic congestion is a common example of this problem. One well-known solution to such problems is admission control. That is, through methods such as entrance ramp meters, entry of new vehicles to the highway is limited to the rate that allows the highway to maintain its peak carrying capacity. Even allowing for delays at the ramp meters, this approach can minimize overall travel times for longer journeys, since the delay due to congestion is non-linear. (Ten percent more vehicles may reduce average speed by 50 percent, not 10 percent, at the limit of throughput.)

Some resources are quickly preempted (meaning they can be used for a different purpose). For example, a memory page containing data that is already on disk may be reassigned to some other use with little overhead, except for the opportunity cost of not having that data in memory, should it later be needed. Similarly, a CPU can be switched from one activity to another with relatively small cost. Other resources, however, take more time and effort to reuse. For example, a main memory page having data that needs to be written to disk cannot be reused until the data is written to NVRAM or to disk. Writing the page to disk, moreover, may increase the load on the disk (for seeks and for bandwidth). So even if one decides to make memory available by reusing pages holding data to be written, other resources in short supply may be needed to do that. Thus a queue of activities waiting for memory may build up even more, due to the writing of the pages having to wait for disk seeks or disk bandwidth. If the requests waiting for memory are more writes, they may wind up recycling cached read pages, which will reduce read performance and further increase the demand for disk seeks and disk bandwidth.

This last point is an example of an issue of concern. Admitting too many writes will make both reads and writes slower, by reducing the effectiveness of read caching without a corresponding increase in the effectiveness of write buffering. Write buffering does help some, in that one can sort a queue of writes by disk address, and thereby increase the effective disk throughput, by writing more data per seek. For a mixed workload, and especially when writes are mostly sequential, however, there is a level of write buffering beyond which there is little to be gained by further increases.

As an example, current disk drives can do about 100 seeks per second, and can transfer about 60 MB (megabytes) per second sequentially. A typical drive can deliver 85 percent or more of its maximum sustained bandwidth with transfers on the order of 512 KB (kilobytes) per seek. If a given level of write buffering can allow writes to be sorted to achieve this level of transfer size per seek, more write buffering will only reduce overall performance, by reducing the effectiveness of read caching (leading to more use of disk seeks by reads). It would therefore be desirable to implement a feedback scheme to limit the admission of writes when the optimal amount of write buffering is in use. The limit may be higher if there are no reads.

For reads, a somewhat similar problem may occur even without writes. If a system queues too many reads, beyond the point where it can achieve efficient use of the disks, it may wind up with so much space reserved for read buffers that it discards too much cached metadata, thereby increasing the average disk seeks per read, by forcing metadata to be read in again. Therefore, it may also be desirable to limit the admission of reads when the disks are already running at high performance.

Another source of contention for memory is network buffering. As with writes, allowing incoming network buffers to grow without bound will cause useful cached data to be discarded, when the extra network buffers simply mean more requests are buffered at the network level, even though they will wind up taking longer to be serviced. Thus, it may be desirable to provide a dynamic limit on the size of network buffers to avoid having more requests queued than a system can serve within the network round trip delay to the clients (which is the time required to get more requests from the clients when the system realizes it can handle more).

Therefore, it would be desirable to provide a system and method for managing the quality of service of a storage system that applies the principle of congestion control, and other techniques, in a manner that is relatively simple to implement in an existing storage system.

### SUMMARY OF THE INVENTION

The present invention provides a system and method for managing quality of service for a storage system. In one embodiment, a system applies the principle of congestion control and other techniques in a manner that is simple to implement in an existing storage system to provide a predictable quality of service. The system may include a Quality of Service (QoS) manager and a request limitation process or “throttle” for limiting requests to the file systems based on measured operational data. The QoS manager may employ various methods for managing quality of service including controlling memory usage of clean pages and other resources, admission control, and controlling the rate at which modified buffers are written to disk.

One non-limiting advantage of the present invention is that it does not require a completely new way of constructing storage systems. Rather, in one embodiment, the present invention can be used to “retrofit” an existing storage system for congestion control, rather than requiring the design of a new and different storage system.

The present invention may be built using a system management mechanism, such as the one described in a prior U.S. patent application Ser. No. 10/170,880, “System and Method for Managing a Distributed Computing System” (the “'880 application”), which is incorporated herein by reference. Particularly, the present invention may implement or form part of the System Management Service (SMS) Monitor described in the '880 application. Alternatively, the invention may form a separate component or process (e.g., a QoS manager that operates independently of the SMS Monitor).

According to one aspect of the present invention, a system is provided for managing quality of service for a storage system including a plurality of file systems that share resources. The system includes a quality of service manager that determines when a file system is exceeding an assigned memory usage and in response, increases a rate at which clean pages of the file system are reused. The system may also include a request limitation process for limiting requests to a file system. In such an embodiment, the quality of service manager further determines when a first file system is using more than an assigned share of a resource that is shared with a second file system and the second file system is not receiving its assigned share of the resource, and in response, signals the request limitation process to limit requests to the first file system. In another embodiment, the quality of service manager may further determine when a file system is using more than an assigned amount of memory and in response, increase a rate at which modified buffers are written to disk for the file system.

According to a second aspect of the invention, a method is provided for managing quality of service in a storage system including a plurality of file systems that share resources. The method includes determining when a file system is exceeding an assigned memory usage and in response, increasing a rate at which clean pages of the file system are reused. The method may further include determining when a first file system is using more than an assigned share of a resource that is shared with a second file system and the second file system is not receiving its assigned share of the resource, and in response, limiting requests to the first file system.

These and other features and advantages of the invention will become apparent by reference to the following specification and by reference to the following drawings.

### BRIEF DESCRIPTION OF THE DRAWINGS

FIG. 1 is a schematic diagram of an exemplary storage system incorporating one embodiment of a system and method for managing quality of service, according to the invention.

FIG. 2 is a block diagram illustrating the general operation of a system management service (SMS) monitor in apportioning resources, according to the invention.

FIG. 3 is a flow diagram illustrating a method for controlling the usage of clean pages that may be employed by the present invention.

FIG. 4 is a flow diagram illustrating a method for admission control that may be employed by the present invention.

### DETAILED DESCRIPTION OF THE EMBODIMENTS

The present invention will now be described in detail with reference to the drawings, which are provided as illustrative examples of the invention so as to enable those skilled in the art to practice the invention. The present invention may be implemented using software, hardware, and/or firmware or any combination thereof, as would be apparent to those of ordinary skill in the art. The preferred embodiment of the present invention will be described herein with reference to an exemplary implementation of a distributed storage system providing one or more file systems. However, the present invention is not limited to this exemplary implementation, but can be practiced in any computing system that includes multiple resources that may be provisioned and configured to provide certain functionalities, performance attributes and/or results.

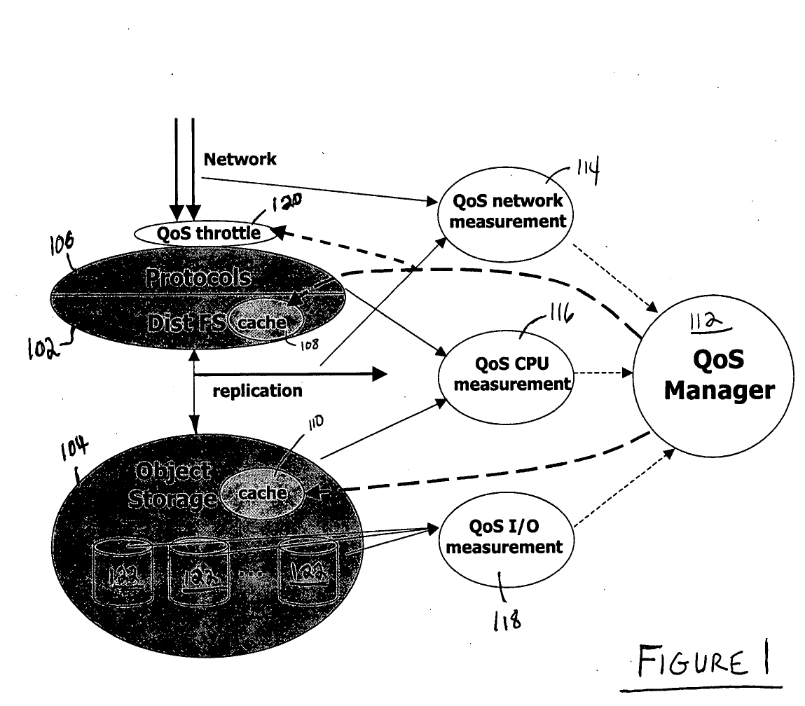

Referring now to FIG. 1, there is shown an exemplary distributed storage system 100 incorporating a system and method for managing quality of service, according to the present invention. In one embodiment, the system 100 includes a distributed file system 102, object storage resources 104, protocol servers or applications 106, a quality of service (QoS) manager 112, measurement processes 114-118, and an admission control mechanism or “QoS throttle” 120.

Distributed file system 102 may include one or more conventional distributed file systems and one or more queues or caches 108 for storing requests to file system 102, such as read and write requests. In one embodiment, the distributed file system 102 may be substantially similar to the distributed virtual file system described in co-pending U.S. patent application Ser. No. 10/866,229, which is assigned to the present assignee and incorporated herein by reference. In other embodiments, file system 102 may be a conventional file system on a single volume (i.e., not distributed), or on multiple volumes (i.e., distributed). Storage resources 104 include a plurality of conventional storage resources or modules 122 for storing electronic data, and one or more caches 110 for storing requests to storage resources 122.

In one embodiment, the protocol servers 106 may include applications for Network Data Management Protocol (NDMP), Network File System (NFS), and Common Internet File System (CIFS). NDMP may be used to control data backup and recovery communications between primary and secondary storage devices. CIFS and NFS may be used to allow users to view and optionally store and update files on remote computers as though they were present on the user's computer. In other embodiments, the system 100 may include applications providing for additional and/or different communication protocols.

The QoS manager 112 may comprise a conventional server, application, computing system or a combination of such devices. In one embodiment, the QoS manager 112 forms a portion of one or more system management service (SMS) servers. Each SMS server may include a configuration database (CDB), which stores state and configuration information relating to the system 100. The SMS servers may include hardware, software and/or firmware that is adapted to perform various system management services. For example, the SMS servers may be substantially similar in structure and function to the SMS servers described in U.S. patent application Ser. No. 10/170,880, “System and Method for Managing a Distributed Computing System” (the “'880 application”), which is incorporated herein by reference. The SMS servers provide various management functions including autonomously and dynamically provisioning and modifying system resources to ensure that the system provides certain user-selected performance attributes and functionality. The SMS servers may further be responsible for other management services such as starting, stopping, and rebooting service nodes, and for loading software onto newly activated nodes. The SMS servers will be collectively referred to as the “SMS Monitor.”

The QoS throttle 120 may be a process adapted to limit file system requests in storage system 100. The QoS manager 112 receives measurement and data regarding the use of system resources by use of various measurement processes such as a network measurement process 114, a CPU measurement process 116, and an I/O measurement process 118. Measurement processes 114-118 may be conventional processes for monitoring respective activities throughout system 100, and may employ conventional counters or other devices to obtain operational readings. Based on the data received from these measurement processes, the QoS manager 112 controls operation of the request throttle 120 and queues or caches 108, 110, as described below.

In operation, the system 100 assigns resources to define and configure each file system 104, and QoS manager 112 contains each file system to operate within its assigned resources, with the exception that QoS manager 112 may allow one or more file systems to use otherwise uncommitted resources if desired. (The permitted usage of uncommitted resources allows users to achieve extra performance when some resources are idle, rather than being limited to a fixed performance at all times.) In one embodiment, the QoS manager 112 may employ several methods to control quality of service. The QoS manager 112 may implement one method to limit and control the usage of clean pages. The QoS manager 112 may implement another method to limit all other resource usage. In addition, the QoS manager 112 may employ another method to provide special consideration when handling modified buffers in memory.

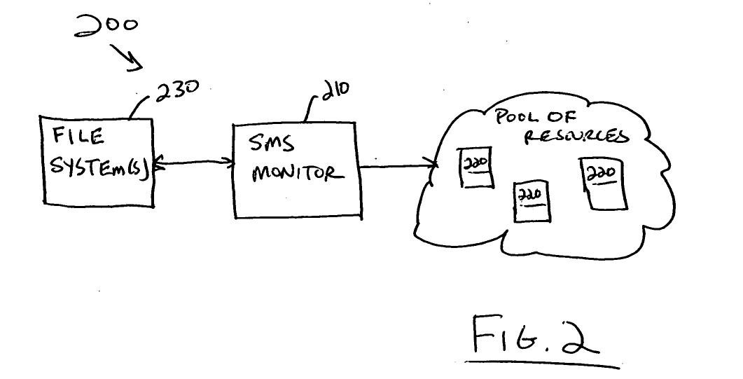

In order to enhance quality of service, the system may initially provide a mechanism that accepts one or more definitions for file systems, including their desired quality of service characteristics, such as performance and reliability, and allocates resources accordingly. The SMS servers or “SMS monitor” may supply this mechanism. FIG. 2 is a schematic diagram 200 illustrating the general operation of an SMS monitor 210 in conjunction with a pool of resources 220, and one or more file systems 230 that may be created by the system using the pool of resources 220. Each file system 230 is implemented using a portion of resources 220. For example, a file system might include resources for providing gateway, metadata and storage services. The SMS monitor 210 will initially allocate one or more machines, servers and disk drives (or portions of such devices) with enough processing power, main memory, and disk space to accommodate the expected requirements of the file system.

The SMS monitor 210 compiles each file system description into a set of required resources, allocates those resources from the pool of available resources 220, and initializes and configures the file system for operation. If the requirements are later changed, the SMS monitor 210 recomputes the required list of resources and adjusts the resource assignments for the running file system. The SMS monitor 210 may compute the resource list from the requirements using empirically derived formulas based on measurements of test configurations, as discussed in the '880 application.

The pool of resources 220 may be apportioned from physical computing devices (e.g., disk drives, processors, servers, and the like) of varying size, performance, capacity and power. The resources may be viewed in terms of performance capabilities. For example, the SMS monitor 210 may control and assign the following resources: disk seeks (moving the disk head to a different area of the disk, usually measured as seeks per second), disk sequential throughput (reading or writing to adjacent locations, usually measured as megabytes per second), main memory space (for caching data for reading, for buffering writes waiting to be transferred to disk, and for caching metadata, such as the location of file data on the disk), main memory bandwidth (for transfers to and from the disks and the network and for CPU access, typically measured in megabytes per second), non-volatile memory (NVRAM) space (used for reliably holding pending writes until they are written to disk), NVRAM bandwidth, CPU time (for processing access protocols, scheduling data movement, and performing file system operations), and network bandwidth (for moving data in and out of the system). In systems where the disks are attached to one or more network ports and multiple disks share a port, the present invention may also control disk access port bandwidth and queuing delays. In addition to the functions discussed herein, the SMS monitor 210 may be adapted to perform the functions of the SMS monitor discussed in the '880 application, such as managing and reallocating resources 220 for file system(s) 230.

Once the SMS monitor 210 assigns resources to the file system(s) 230, it informs the QoS manager of the resource assignments. The QoS manager 112 uses this information to enforce quality of service as described below.

Methods for Quality of Service Enforcement

A. Controlling Memory Usage for Clean Pages

A first method for enforcing quality of service is to control memory usage with respect to clean pages. Particularly, the QoS manager 112 controls the memory usage for clean pages in order to limit the memory used by each file system. It would be possible to construct an explicit memory reservation scheme, to limit the memory used by each file system. It is common, however, in contemporary operating systems, such as Linux, that main memory is treated as a single large pool, with memory usage constraints placed only on user processes, not on the use of memory by file systems within the operating system kernel. Thus, in order to implement quality of service enforcement with minimal change to an existing operating system, the present invention instead operates by changing the order in which pages are recycled for new uses. Specifically, the QoS manager 112 maintains a running total of pages used by a given file system, both clean pages (which can be recycled without being written to disk) and dirty pages (which must be written before being recycled).

Clean pages are typically maintained by an operating system on a list or queue in approximately least recently used (LRU) order. When a page is needed for a new use, the first page on the list is taken, as it is the least recently used. The QoS manager 112 limits the page use by a file system that is exceeding its assigned memory usage by moving that file system's clean pages toward the front of the LRU list, ahead of pages of file systems that are not exceeding their assigned memory usage. This causes file systems that are over their target memory usage to preferentially reuse pages belonging to themselves, rather than taking pages from other file systems and thereby reducing the cache efficiency seen by those file systems.

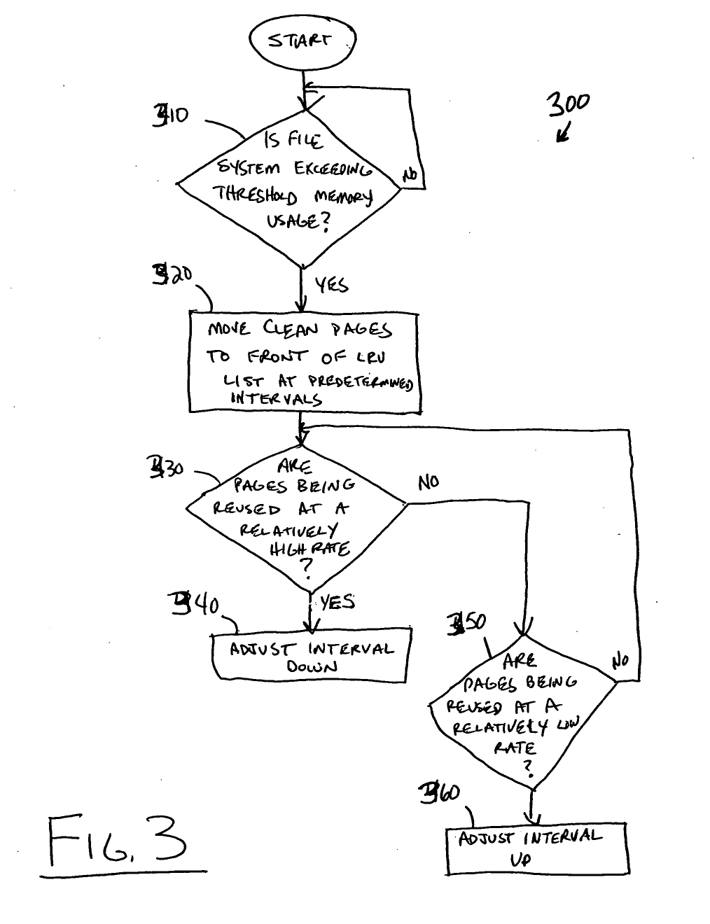

FIG. 3 illustrates one example of a method 300 that may be implemented by the QoS manager 112 to control the use of clean pages. In block 310, the QoS manager 112 determines if a given file system is exceeding its assigned memory usage by a predetermined threshold value or percentage. If the file system is exceeding its assigned memory usage, the method proceeds to block 320, where the QoS manager 112 begins moving the file system's clean pages to the front of the LRU list incrementally at predetermined intervals. In step 330, the QoS manager 112 monitors the rate at which the pages are being reused. If pages are being reused at a relatively high rate (e.g., above a certain threshold value), the method proceeds to step 340. In step 340, the QoS manager 112 adjusts the interval to be shorter. The amount that the interval is shortened may be based on the measured rate of reuse. If the page reuse rate is not relatively high, the method proceeds to step 350 and determines whether the rate is relatively low. If pages are being reused at a relatively low rate (e.g., below a certain threshold), the method proceeds to step 360, where the QoS manager 112 adjusts the interval to be longer. It should be appreciated that the method 300 may include additional and/or different steps based on specific applications. For example, in one embodiment, the QoS manager 112 only moves enough pages forward to make it likely that pages reused will be taken from the file system or file systems that are over their assigned resources. The number of pages moved forward may be determined in a conventional manner based on feedback or test data. In one embodiment, in order to avoid excessive reordering of the queue, some hysteresis may be applied in the threshold value or percentage used to determine whether a file system is exceeding its assigned resource usage.

As described, this method will cause file systems that are over their target memory usage to preferentially reuse pages belonging to themselves, rather than taking pages from other file systems and thereby reducing the cache efficiency seen by those file systems.

B. Request Throttling

Another method that the QoS manager 112 may implement to control resource usage is admission control or “request throttling.” This method includes periodically comparing all resource usage for a given file system (e.g., disk I/O, CPU time, dirty memory usage, network bandwidth, and the like) against target values. QoS manager 112 receives these measured usage values from measurement processes 114-118 and compares the received values to predetermined values that can be set by a user or system administrator based on desired file system performance. Based on the resource usage comparisons, the QoS manager 112 may signal the QoS throttle process 120 to limit requests to file systems that are using over an assigned amount of resources.

It should be appreciated that relevant resource usage should be counted, which may suggest providing additional counters and/or measurement processes in some embodiments, e.g., if the operating system and/or storage system does not already have them. It should be appreciated that some of the association of counters to file systems can be implied, rather than direct. For example, if the system implements counters for each disk, recording its activity, and we know that disk A is used by file system B, we can treat the usage of disk A as being part of the usage of file system B.

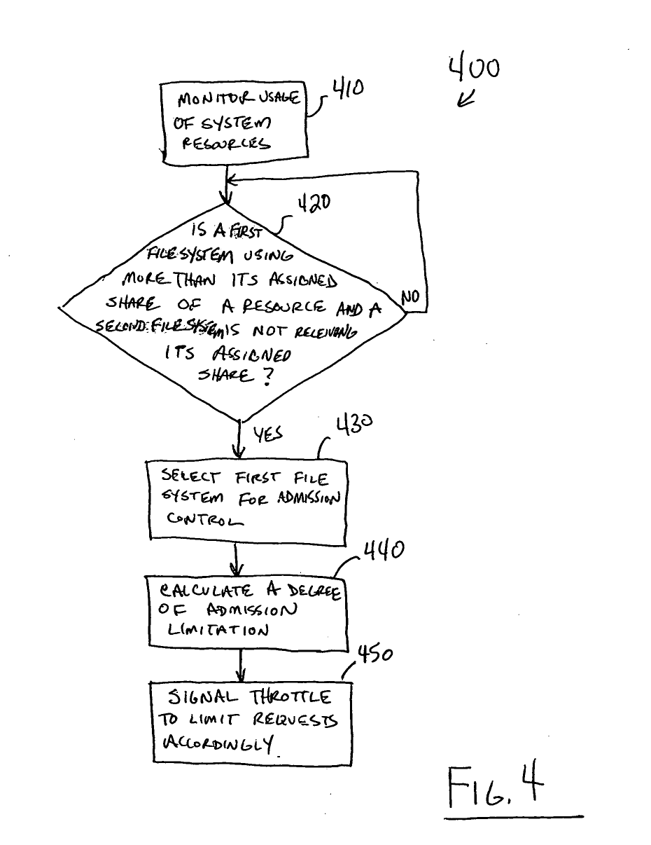

FIG. 4 illustrates one example of a method 400 for controlling resource usage, according to the present invention. In block 410, the QoS manager 112 monitors the usage of system resources that are shared by file systems. In block 420, the QoS manager 112 determines whether a first file system is using significantly more than its assigned share of a given resource (e.g., exceeding a predetermined percentage), which is shared with a second file system, and whether the second file system is not receiving its assigned share of the resource. If this is the case, the QoS manager 112 selects the first file system for admission control, as shown in block 430. In block 440, the QoS manager 112 calculates a degree or level of admission limitation. As used herein, the term “admission limitation” should be understood to include the limiting the use of any resources by a file system, for example, by limiting file system requests. The degree of admission limitation may be estimated from the proportion of the excess usage to the assigned usage (e.g., proportion of requests admitted=1/proportion of current usage of assigned/assigned usage; or proportion of requests admitted=assigned usage/current usage). For instance, if usage is 110% of the assigned level, the QoS manager 112 will begin by limiting requests to about 91% of the rate currently being processed. For subsequent measurements, the percentage of limitation may be adjusted in a feedback scheme. That is, if after some limitation, the resource usage is still too high, the control method may further reduce the target rate of requests; if the resource usage drops below target, the QoS manager 112 may increase the target rate of requests. In step 450, the QoS manager 112 implements the request limitations, e.g., by signaling the QoS throttle 120 to limit the requests coming into the first file system in the calculated manner.

The QoS throttle 120 communicates the target rate to all sources of new requests. In a network-attached storage system, this will include each of the storage access protocol processing elements 106, such as the NFS server, the CIFS server, the NDMP server, and the like. Each such server then reduces its effective rate of requests by randomly delaying a percentage of requests, for requests arriving via reliable transports (such as TCP), and by randomly dropping a percentage of requests, for requests arriving via unreliable transports (such as NFS over UDP). For services implemented in the operating system kernel, this target rate may be conveyed via the operating system's normal method of delivering control parameters. For services implemented in user space, the target rate may be conveyed by whatever method the service has for accepting runtime parameter changes, such as updating a control file that the service then reads periodically, or by connecting to a control interface.

C. Special Consideration for Handling Modified Buffers in Memory

In one embodiment, the storage system may also provide a method of adjusting the rate at which modified buffers in memory (e.g., caches 108, 110) are written to disk for a given file system. In such an embodiment, the QoS manager 112 may increase system efficiency by increasing that rate for a given file system when that file system is using too much memory or is using significantly more memory that its assigned amount (and other file systems are not). In this manner, the file system will not see excessive replacement of its cached pages. While throttling requests will further decrease the rate at which dirty buffers are created, throttling requests may not be necessary, if the ratio of dirty to clean buffers can be reduced, thereby reducing disk reads (to replace discarded cached pages) at the cost of increasing disk writes.

If the ratio of a file system's modified buffers to clean buffers is still too “high” (e.g., due to writes arriving faster than they can be retired), the QoS manager 112 may act to throttle only incoming write requests (or to throttle them more than reads), if the protocol supports doing so. This will particularly help in limiting the effect on read latency, to which applications are most sensitive, at some cost in increased write latency. (For many file protocols, client systems may buffer writes, thereby masking write latency to some extent.)

Using the foregoing methods, the present invention provides improved quality of service for a storage system. The methods employed by the present invention do not require a completely new way of constructing storage systems. Instead, the present invention may implement the methods by “retrofitting” an existing storage system for congestion control, rather than requiring the design of a new and different storage system.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications. It should be further apparent to those skilled in the art that the various embodiments are not necessarily exclusive, but that features of some embodiments may be combined with features of other embodiments while remaining with the spirit and scope of the invention.

What is claimed is:

1. A system for managing quality of service for a storage system including a plurality of file systems that share resources, the system comprising:
a quality of service manager that determines when a file system is exceeding an assigned memory usage and in response, increases a rate at which clean pages of the file system are reused.

2. The system of claim 1 further comprising:
a list of clean pages available in the storage system organized in least recently used order;
wherein the quality of service manager increases the rate at which clean pages of the file system are reused by moving the clean pages to the front of the list incrementally at predetermined intervals.

3. The system of claim 2 wherein the quality of service manager determines when pages are being reused at a relatively high rate and in response, shortens the predetermined intervals.

4. The system of claim 3 wherein the quality of service manager determines when pages are being reused at a relatively low rate and in response, lengthens the predetermined intervals.

5. The system of claim 2 wherein the quality of service manager determines an amount of clean pages to move to the front of the list at the predetermined intervals, wherein the amount is sufficient such that pages reused will more likely be taken from the file system than from other file systems.

6. The system of claim 1 further comprising:
a request limitation process for limiting requests to a file system; and
wherein the quality of service manager further determines when a first file system is using more than an assigned share of a resource that is shared with a second file system and the second file system is not receiving its assigned share of the resource, and in response, signals the request limitation process to limit requests to the first file system.

7. The system of claim 6 wherein the request limitation process limits requests to the first file system based on a proportion of excess resource usage over assigned resource usage.

8. The system of claim 6 wherein the quality of service manager further determines when a file system is using more than an assigned amount of memory and in response, increases a rate at which modified buffers are written to disk for the file system.

9. The system of claim 8 wherein the quality of service manager further determines when a ratio of modified buffers to clean buffers for a file system is too high and in response, limits incoming write requests to the file system.

10. A method of managing quality of service in a storage system including a plurality of file systems that share resources, the method comprising:
determining when a file system is exceeding an assigned memory usage and in response, increasing a rate at which clean pages of the file system are reused.

11. The method of claim 10 further comprising:
maintaining a list of clean pages available in the storage system organized in least recently used order; and
increasing the rate at which clean pages of the file system are reused by moving the clean pages to the front of the list incrementally at predetermined intervals.

12. The method of claim 11 further comprising:
determining when pages are being reused at a relatively high rate and in response, shortening the predetermined intervals.

13. The method of claim 12 further comprising:
determining when pages are being reused at a relatively low rate and in response, lengthening the predetermined intervals.

14. The method of claim 13 further comprising:
determining an amount of clean pages to move to the front of the list at the predetermined intervals, wherein the amount is sufficient such that pages reused will more likely be taken from the file system than from other file systems.

15. The method of claim 10 further comprising:
determining when a first file system is using more than an assigned share of a resource that is shared with a second file system and the second file system is not receiving its assigned share of the resource, and in response, limiting requests to the first file system.

16. The method of claim 15 wherein requests to the first file system are limited based on a proportion of excess resource usage over assigned resource usage.

17. The method of claim 15 further comprising:
determining when a file system is using more than an assigned amount of memory and in response, increasing a rate at which modified buffers are written to disk for the file system.

18. The method of claim 17 further comprising:
determining when a ratio of modified buffers to clean buffers for a file system is too high and in response, limits incoming write requests to the file system.
